(19) United States
(12) Patent Application Publication
(10) Pub. No.: US 2012/0105497 A1
(43) Pub. Date: May 3, 2012

(54) AUTO-STEREOSCOPIC 3D DISPLAY AND DISPLAY METHOD THEREOF

(75) Inventors: Pei-Hua Lu, Tainan County (TW); Hong-Shen Lin, Miaoli County (TW); Chun-Wei Wu, Chiayi City (TW); Lee-Hsun Chang, Hsinchu County (TW)

(73) Assignee: AU OPTRONICS CORPORATION, Hsinchu (TW)

(21) Appl. No.: 13/244,090

(22) Filed: Sep. 23, 2011

(30) Foreign Application Priority Data
Oct. 27, 2010 (TW) 99136806

(51) Int. Cl. G09G 3/36; G09G 3/32; G09G 5/10

(52) U.S. Cl. 345/690; 345/87; 345/77

(57) ABSTRACT

An auto-stereoscopic 3D display and a display method thereof are provided. The auto-stereoscopic 3D display includes a display module and a scanning barrier. The display module displays a 2D image. The scanning barrier is attached on the display module. The scanning barrier coordinates with the 2D image displayed by the display module to provide a switching of a plurality of alternate vertical slits and vertical barriers, so that a parallax is produced between a left eye and a right eye and accordingly a 3D image is sensed, wherein a constant opaque area exists between each of a pair of the slit and the barrier.

### CROSS-REFERENCE TO RELATED APPLICATION

This application claims the priority benefit of Taiwan application serial no. 99136806, filed Oct. 27, 2010. The entirety of the above-mentioned patent application is hereby incorporated by reference herein and made a part of this specification.

### BACKGROUND

1. Technical Field

The disclosure generally relates to a 3D display technique, and more particularly, to an auto-stereoscopic 3D display and a display method thereof.

2. Description of Related Art

Parallax stereogram is a technique by which 3D images are presented to human eyes. In this technique, images presented to the left eye and the right eye are respectively cut along vertical pixel lines. Then, an integrated image is generated by re-arranging the cut images alternatively. When the integrated image is displayed, a parallax barrier is placed in front of the image so that the left eye image and the right eye image in the integrated image are respectively captured by the left and right eyes through the barrier effect of the parallel opaque stripes and a sense of depth is produced in the human brain, which is called the parallax barrier technique.

Generally speaking, most existing displays display only 2D images instead of 3D images. Thus, presently, the switch ability between 2D images and 3D images is usually taken into consideration in the design of a liquid crystal display (LCD). An LCD with the liquid crystal layer thereof as the parallax barrier (i.e., liquid crystal (LC) scanning barrier) has been provided, wherein the LC scanning barrier is not used for displaying images but only for switching between 2D and 3D images.

To be specific, when an LCD with an LC scanning barrier displays a 2D image, all the liquid crystal molecules in the LC scanning barrier are in a light transmissive state. However, when the LCD with the LC scanning barrier displays a 3D image, all the liquid crystal molecules in the LC scanning barrier provide a switching of a plurality of vertical alternate slits and barriers (i.e., all the liquid crystal molecules in the LC scanning barrier switch between a transmissive state and a non-transmissive state at different time points).

Accordingly, as the parallax barrier described above, (transmissive) vertical slits and (non-transmissive) vertical barriers are alternately formed in the LC scanning barrier, such that a 3D image can be sensed by the human eyes. However, in an LCD with the LC scanning barrier design, light leakage is likely to happen between the transmissive slit and non-transmissive barrier due to imperfect attachment between the LC scanning barrier and the LCD.

FIG. 1 is a diagram illustrating the switching of a conventional LC scanning barrier. Referring to FIG. 1, herein it is assumed that the LC scanning barrier has four areas R1-R4. Theoretically, at the first time point t1, the areas R1 and R3 of the LC scanning barrier are non-transmissive barriers, and the areas R2 and R4 of the LC scanning barrier are transmissive slits. Meanwhile, one of the left eye image and the right eye image (for example, the left eye image) captured by the left eye is displayed through the transmissive slits R2 and R4. Thereafter, at the second time point t2, the areas R1 and R3 of the LC scanning barrier are transmissive slits, and the areas R2 and R4 of the LC scanning barrier are non-transmissive barriers. Meanwhile, the other one of the left eye image and the right eye image (i.e. the right eye image) captured by the right eye is displayed through the transmissive slits R1 and R3.

However, if the LC scanning barrier is imperfectly attached to the LCD (i.e., unaligned attachment), light leakage will happen at an area B between each pair of the transmissive slit and the non-transmissive barrier of the LC scanning barrier. Thereby, the 3D image display quality of the LCD is greatly affected.

### SUMMARY OF DISCLOSURE

The disclosure provides an auto-stereoscopic 3D display including a display module and a scanning barrier. The display module displays a 2D image. The scanning barrier is attached on the display module. The scanning barrier coordinates with the 2D image displayed by the display module to provide a switching of a plurality of alternate vertical slits and vertical barriers, and a constant opaque area is generated between each of a pair of the slit and the barrier during the time for displaying a 3D image.

According to an embodiment, the display module may be a liquid crystal display (LCD) module or an organic light emitting diode (OLED) display module.

According to an embodiment, a width of each of the pair of slit and the barrier forms a barrier pitch of the scanning barrier.

According to an embodiment, the scanning barrier may be a liquid crystal (LC) scanning barrier.

According to an embodiment, the scanning barrier includes a plurality of non-display pixels, wherein the non-display pixels are arranged as an array and are categorized into a plurality of groups.

According to an embodiment, the groups include a first sub group, a second sub group, and a third sub group, wherein the third sub group is between the first sub group and the second sub group. Each of the non-display pixels in the first sub group and each of the non-display pixels in the second sub group serve as one slit or one barrier and are switched respectively between the slit and the barrier in response to a first driving signal set and a second driving signal set, and one of the non-display pixels in the first sub group and one of the non-display pixels in the second sub group adjacent to the one of the non-display pixels in the first sub group consist of the pair of the slit and the barrier. Each of the non-display pixels in the third sub group serves as the constant opaque area between each of the pair of the slit and the barrier in response to a third driving signal set.

According to an embodiment, the display module further includes a display module controller; the scanning barrier further includes a switching barrier controller; and the display module controller provides a synchronization signal to the switching barrier controller such that the switching barrier controller generates the first driving signal set, the second driving signal set, and the third driving signal set and accordingly the scanning barrier and the display module are controlled to display synchronously.

The disclosure also provides an auto-stereoscopic 3D display method including following steps of displaying a 2D image by a display module; coordinating with the 2D image to provide a switching of a plurality of alternate vertical slits and vertical barriers by a scanning barrier attached on the display module; and producing a constant opaque area between each of a pair of the slit and the barrier by the scanning barrier.

According to an embodiment, the scanning barrier includes a plurality of non-display pixels arranged as an array and categorized into a first to a third sub groups, the third sub group is located between the first sub group and the second group, and the switching of the plurality of vertical alternate slits and barriers is produced by providing a first driving signal set and a second driving signal set to respectively switch the first sub group and the second sub group, wherein each of the non-display pixels in the first sub group and each of the non-display pixels in the second sub group serve as one slit or one barrier and are switched respectively between the slit and the barrier in response to the first driving signal set and the second driving signal set, and one of the non-display pixels in the first sub group and one of the non-display pixels in the second sub group adjacent to the one of the non-display pixels in the first sub group consist of the pair of the slit and the barrier.

According to an embodiment, the constant opaque area is produced by providing a third driving signal set to the third sub group, wherein each of the non-display pixels in the third sub group serves as the constant opaque area between each of the pair of the slit and the barrier in response to the third driving signal set.

As described above, constant opaque areas are produced along with the switching of a plurality of alternate vertical slits and vertical barriers provided by an LC scanning barrier. Thereby, not only the error tolerance of the attachment between the LC scanning barrier and an LCD is increased, but light leakage between any two adjacent areas (i.e., a transmissive slit and a non-transmissive barrier) of the LC scanning barrier is effectively prevented, so that the 3D image display quality of the LCD is ensured even when the LC scanning barrier cannot be perfectly attached to the LCD.

It should be understood that foregoing descriptions and following embodiments are not intended to limit the scope and spirit of the disclosure.

### BRIEF DESCRIPTION OF THE DRAWINGS

The accompanying drawings are included to provide a further understanding, and are incorporated in and constitute a part of this specification.

FIG. 1 is a diagram illustrating the switching of a conventional LC scanning bather.

FIG. 2 is a diagram of an auto-stereoscopic 3D display according to an embodiment.

FIG. 3 is a diagram of an LC scanning barrier according to an embodiment.

FIG. 4 is a diagram illustrating the switching of an LC scanning barrier according to an embodiment.

FIG. 5 is a flowchart of a method for displaying an auto-stereoscopic 3D image according to an embodiment.

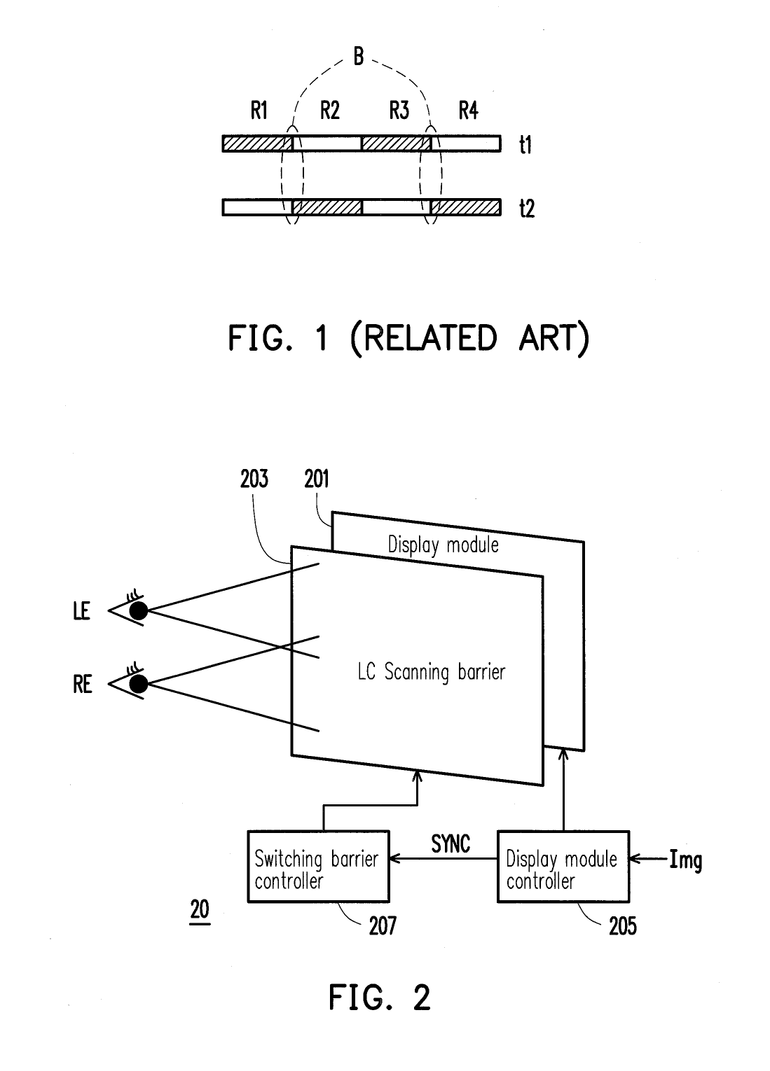

### DESCRIPTION OF THE EMBODIMENTS

Reference will now be made in detail to the present embodiments, examples of which are illustrated in the accompanying drawings. Wherever possible, the same reference numbers are used in the drawings and the description to refer to the same or like parts.

FIG. 2 is a diagram of an auto-stereoscopic 3D display 20 according to an embodiment. Referring to FIG. 2, the auto-stereoscopic 3D display 20 includes a display module 201 and a scanning barrier 203. The display module 201 may be a liquid crystal display (LCD) module or an organic light emitting diode (OLED) display module. Besides, the scanning barrier 203 may be a liquid crystal (LC) scanning barrier, and which will be referred to as an LC scanning barrier 203 thereinafter.

In the present embodiment, the display module 201 includes a display panel (not shown), a gate driving device (not shown), a source driving device (not shown), and a display module controller 205 (which may be a timing controller (T-con), not shown). Besides, the display module 201 may further include a backlight module (not shown) selectively. Namely, if the display module 201 is an LCD module, it has to have a backlight module, but if the display module 201 is an OLED display module, it needs not to have a backlight module.

Generally speaking, the display module controller 205 controls the operations of the gate driving device and the source driving device according to an inputted image signal Img, so as to drive the display pixels (not shown) in the display panel. In addition, with the backlight source provided by the backlight module or the self-emission characteristic of the OLED, the display module 201 displays a 2D image.

The LC scanning barrier 203 is attached on the display module 201. The LC scanning barrier 203 coordinates with the 2D image displayed by the display module 201 to provide a switching of a plurality of alternate (transmissive) vertical slits (also can be called as “transmissive areas”) and (non-transmissive) vertical barriers (also can be called as “non-transmissive areas”), so that parallax is produced between a left eye LE and a right eye RE and accordingly a 3D image is viewed by a viewer.

To be specific, the display module controller 205 provides a synchronization signal SYNC to a switching barrier controller 207 (considered as a part of the LC scanning barrier 203). Accordingly, the LC scanning barrier 203 is controlled by the switching barrier controller 207. During the time for displaying a 3D image, the LC scanning barrier 203 would coordinate with the 2D image displayed by the display module 201 to provide the switching of the alternate (transmissive) vertical slits and (non-transmissive) vertical barriers, and a constant opaque area between each of a pair of the slit and the barrier is generated.

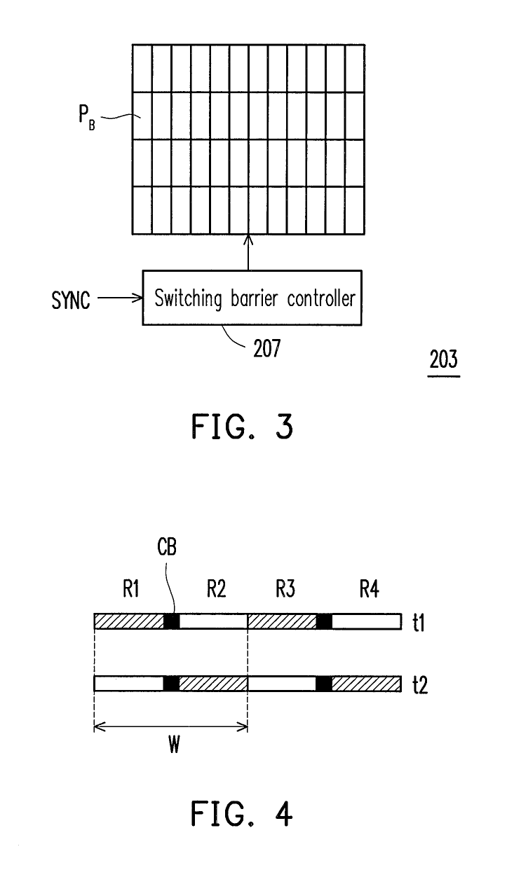

On the other hand, the LC scanning barrier 203 further includes a plurality of non-display pixels P_{B} arranged as an array, such as (not limited to) the 12*4 non-display pixels P_{B} in FIG. 3. In other words, the non-display pixels P_{B} are disposed on the display module 201. The non-display pixels P_{B} are categorized into a plurality of groups, such as (not limited to) a first sub group, a second sub group, and a third sub group, as shown in FIG. 4. In the present embodiment, the third sub group is located between the first sub group and the second sub group, the first sub group and the second sub group provide the switching of the alternate transmissive slits and non-transmissive barriers respectively in response to a first driving signal set and a second driving signal set generated by the switching barrier controller 207, and the third sub group forms the constant opaque area CB between each of the pair of the transmissive slit and the non-transmissive barrier in response to a third driving signal set generated by the switching barrier controller 207. To be specific, each of the non-display pixels P_{B} in the first sub group and each of the non-display pixels P_{B} in the second sub group serve as one slit or one barrier and are switched respectively between the slit and the barrier in response to the first driving signal set and the second driving signal set, and one of the non-display pixels P_{B} in the first sub group and one of the non-display pixels P_{B} in the second sub group adjacent to the one of the non-display pixels P_{B} in the first sub group consist of the pair of the slit and the barrier; moreover, each of the non-display pixels P_{B} in the third sub group serves as the constant opaque area between each of the pair of the slit and the barrier in response to the third driving signal set. In other words, once the display module controller 205 provides the synchronization signal SYNC to the switching barrier controller 207, the switching barrier controller 207 generates the first to the third driving signal sets to control the LC scanning barrier 203 and the display module 201 to display synchronously the 3D image.

In this case, the width W of three non-display pixels P_{B} forms a barrier pitch of the LC scanning barrier 203, and which is equal to the width of R1, CB, and R2 or the width of R3, CB, and R4, as shown in FIG. 4. Besides, the non-display pixels P_{B} in the first to the third sub groups may have different widths. Preferably, the widths of the non-display pixels P_{B} in the first and the second sub groups are the same, and which is greater than the width of the non-display pixels P_{B} in the third sub group. However, the widths of the non-display pixels P_{B} in the three sub groups are determined according to the actual design requirement.

Referring to FIG. 3, among the 12*4 non-display pixels P_{B}, the non-display pixels in the (3i+1)^{th} column are categorized into the first sub group, the non-display pixels in the (3i+2)^{th} column are categorized into the third sub group, and the non-display pixels in the (3i+3)^{th} column are categorized into the second sub group, wherein i is zero or a positive integer. Accordingly, the non-display pixels in the (3i+1)^{th} column and the (3i+3)^{th} column provide the switching of the alternate transmissive slits and non-transmissive barriers in response to the first driving signal set and the second driving signal set generated by the switching barrier controller 207, and non-display pixels in the (3i+2)^{th} column form the constant opaque area between each of the pair of the transmissive slit and the non-transmissive barrier in response to the third driving signal set generated by the switching barrier controller 207. In other words, there is a constant opaque area between each of a pair of the slit and the barrier, and the width W of each of the pair of the transmissive slit and the non-transmissive barrier forms a barrier pitch of the LC scanning barrier 203.

To be specific, FIG. 4 is a diagram illustrating the switching of an LC scanning barrier according to an embodiment. Referring to FIGS. 2-4, at the first time point t1, the pixels R1 and R3 of the LC scanning barrier 203 are non-transmissive barriers, and the pixels R2 and R4 of the LC scanning barrier 203 are transmissive slits. Meanwhile, the left eye image captured by the left eye, for example, is displayed through the transmissive slits R2 and R4. Thereafter, at the second time point t2, the pixels R1 and R3 of the LC scanning barrier 203 become transmissive slits, while the pixels R2 and R4 of the LC scanning barrier 203 become non-transmissive barriers. Meanwhile, the right eye image captured by the right eye is displayed through the transmissive slits R1 and R3.

As shown in FIG. 4, there is a constant opaque area (pixel) CB between each of the pair of the (transmissive) slit and the (non-transmissive) barrier regardless of whether it is at the first time point t1 or the second time point t2. Accordingly, in the case that the LC scanning barrier 203 cannot be perfectly attached on the display module 201 (i.e., attachment error), no light leakage will be produced between each pair of transmissive slit and non-transmissive barrier of the LC scanning barrier 203.

In other words, in the present embodiment, the error tolerance of the attachment between the LC scanning barrier 203 and the display module 201 is increased through these constant opaque areas CB, and an ideal range of the width of each constant opaque area CB (i.e., the width of the (non-display) pixels in the (3i+2)^{th} column in FIG. 3) can be determined according to the actual design requirement provided that the displayed 3D images are not affected. Accordingly, light leakage between each pair of transmissive slit and non-transmissive barrier of the LC scanning barrier 203 can be effectively prevented, so that the display quality of the displayed 3D images won't be affected even if the LC scanning barrier 203 and the display module 201 can't be perfectly attached.

It should be mentioned herein that in the present embodiment, all the non-display pixels P_{B} in the LC scanning barrier 203 may be categorized into a plurality of groups according to the number of views of the auto-stereoscopic 3D display 20. Thus, once the number of views of the auto-stereoscopic 3D display 20 is determined, all the non-display pixels P_{B} of the LC scanning barrier 203 can be divided in both the vertical direction and the horizontal direction (how the non-display pixels P_{B} are divided in the vertical direction and the horizontal direction should be determined according to the actual design requirement) so that the auto-stereoscopic 3D display 20 can possess a multi-view function.

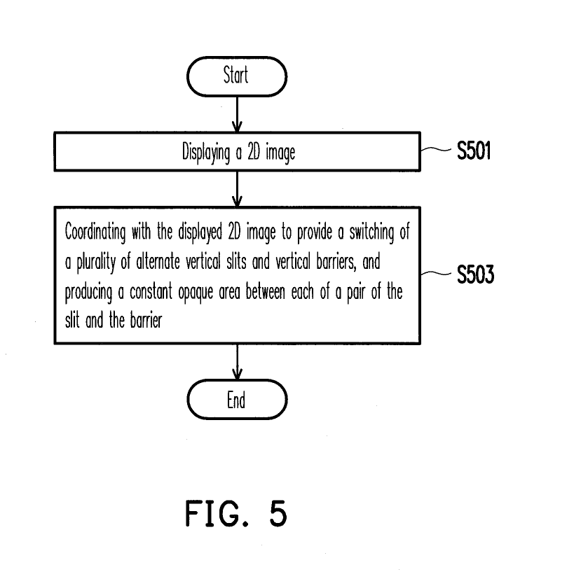

FIG. 5 is a flowchart of a method for displaying an auto-stereoscopic 3D image according to an embodiment. Referring to FIG. 5, the auto-stereoscopic 3D display method in the present embodiment includes following steps. In step S501, displaying a 2D image by a display module such as an LCD module or an OLED display module. In step S503, by a scanning barrier (specifically, an LC scanning barrier) attached on the display module, coordinating with the displayed 2D image to provide a switching of a plurality of alternate vertical slits and vertical barriers, and producing a constant opaque area between each pair of the slit and the barrier, so that parallax is produced between a left eye and a right eye of a viewer and accordingly a 3D image is viewed by the viewer.

In the present embodiment, the scanning barrier includes a plurality of non-display pixels arranged as an array and categorized into a first to a third sub groups, wherein the third sub group is located between the first sub group and the second sub group, and the switching of the plurality of alternate vertical slits and vertical barriers in step S503 is produced by providing a first driving signal set and a second driving signal set to respectively switch the first sub group and the second sub group. Similarly, each of the non-display pixels in the first sub group and each of the non-display pixels in the second sub group serve as one slit or one barrier and are switched respectively between the slit and the barrier in response to the first driving signal set and the second driving signal set, and one of the non-display pixels in the first sub group and one of the non-display pixels in the second sub group adjacent to the one of the non-display pixels in the first sub group consist of the pair of the slit and the barrier. In the other hands, the constant opaque area in step S503 is produced by providing a third driving signal set to the third sub group, wherein each of the non-display pixels in the third sub group serves as the constant opaque area between each of the pair of the slit and the barrier in response to the third driving signal set.

In summary, constant opaque areas are produced along with the switching of a plurality of alternate vertical slits and vertical barriers provided by an LC scanning barrier. Thereby, not only the error tolerance of the attachment between the LC scanning barrier and an LCD is increased, but light leakage between any two adjacent areas (i.e., a transmissive slit and a non-transmissive barrier) of the LC scanning barrier is effectively prevented, so that the 3D image display quality of the LCD is ensured even when the LC scanning barrier cannot be perfectly attached to the LCD.

It will be apparent to those skilled in the art that various modifications and variations can be made to the structure without departing from the scope or spirit. In view of the foregoing, it is intended that the invention cover modifications and variations of this invention provided they fall within the scope of the following claims and their equivalents.

What is claimed is:

1. An auto-stereoscopic 3D display, comprising:
a display module, for displaying a 2D image; and
a scanning barrier, attached on the display module, for coordinating with the 2D image displayed by the display module to provide a switching of a plurality of alternate transmissive slits and non-transmissive barriers, wherein and to provide a constant opaque area between each of a pair of the slit and the barrier during the time for displaying a 3D image.

2. The auto-stereoscopic 3D display according to claim 1, wherein the display module is a liquid crystal display (LCD) module or an organic light emitting diode (OLED) display module.

3. The auto-stereoscopic 3D display according to claim 1, wherein a width of each of the pair of the slit and the barrier forms a barrier pitch of the scanning barrier.

4. The auto-stereoscopic 3D display according to claim 1, wherein the scanning barrier is a liquid crystal (LC) scanning barrier.

5. The auto-stereoscopic 3D display according to claim 4, wherein the scanning barrier comprises:
a plurality of non-display pixels, arranged as an array and categorized into a plurality of groups.

6. The auto-stereoscopic 3D display according to claim 5, wherein the groups comprise:
a first sub group;
a second sub group; and
a third sub group, located between the first sub group and the second sub group,
wherein each of the non-display pixels in the first sub group and each of the non-display pixels in the second sub group serve as one slit or one barrier and are switched respectively between the slit and the barrier in response to a first driving signal set and a second driving signal set, and one of the non-display pixels in the first sub group and one of the non-display pixels in the second sub group adjacent to the one of the non-display pixels in the first sub group consist of the pair of the slit and the barrier; and
wherein each of the non-display pixels in the third sub group serves as the constant opaque area between each of the pair of the slit and the barrier in response to a third driving signal set.

7. The auto-stereoscopic 3D display according to claim 6, wherein
the display module comprises a display module controller;
the scanning barrier further comprises a switching barrier controller; and
the display module controller provides a synchronization signal to the switching barrier controller such that the switching barrier controller generates the first driving signal set, the second driving signal set, and the third driving signal set and accordingly the scanning barrier and the display module are controlled to display synchronously the 3D image.

8. A method for displaying an auto-stereoscopic 3D image, comprising:
displaying a 2D image by a display module;
coordinating with the 2D image to provide a switching of a plurality of alternate transmissive slits and non-transmissive barriers by a scanning barrier attached on the display module; and
producing a constant opaque area between each pair of the slit and the barrier.

9. The method according to claim 8, wherein the scanning barrier comprises a plurality of non-display pixels arranged as an array and categorized into a first to a third sub groups, the third sub group is located between the first sub group and the second group, and the switching of the plurality of vertical alternate slits and barriers is produced by:
providing a first driving signal set and a second driving signal set to respectively switch the first sub group and the second sub group,
wherein each of the non-display pixels in the first sub group and each of the non-display pixels in the second sub group serve as one slit or one barrier and are switched respectively between the slit and the barrier in response to the first driving signal set and the second driving signal set, and one of the non-display pixels in the first sub group and one of the non-display pixels in the second sub group adjacent to the one of the non-display pixels in the first sub group consist of the pair of the slit and the barrier.

10. The method according to claim 9, wherein the step of producing a constant opaque area between each pair of the slit and the barrier by the scanning barrier comprises:
providing a third driving signal set to the third sub group,
wherein each of the non-display pixels in the third sub group serves as the constant opaque area between each of the pair of the slit and the barrier in response to the third driving signal set.

11. An auto-stereoscopic 3D display, comprising:
a display module, for displaying a 2D image; and
a plurality of non-display pixels, disposed on the display module, for coordinating with the 2D image displayed by the display module to provide a switching of a plurality of alternate transmissive areas and non-transmissive areas, and to provide a constant opaque area between each of a pair of the transmissive area and the non-transmissive area in response to several driving signal sets.

12. The auto-stereoscopic 3D display according to claim 11, wherein
the non-display pixels are arranged as an array and categorized into a first to a third sub groups, and the third sub group is located between the first sub group and the second group; and
the driving signal sets comprises a first to a third driving signal sets.

13. The auto-stereoscopic 3D display according to claim 12, wherein
each of the non-display pixels in the first sub group and each of the non-display pixels in the second sub group serve as one transmissive area or one non-transmissive area and are switched respectively between the transmissive area and the non-transmissive area in response to the first driving signal set and the second driving signal set, and one of the non-display pixels in the first sub group and one of the non-display pixels in the second sub group adjacent to the one of the non-display pixels in the first sub group consist of the pair of the transmissive area and the transmissive area; and
each of the non-display pixels in the third sub group serves as the constant opaque area between each of the pair of the transmissive area and the non-transmissive area in response to the third driving signal set.

14. The auto-stereoscopic 3D display according to claim 12, wherein
non-display pixels are formed as an LC scanning barrier.

15. The auto-stereoscopic 3D display according to claim 11, wherein the display module is a liquid crystal display (LCD) module or an organic light emitting diode (OLED) display module.
